(19) United States
(12) Patent Application Publication
(10) Pub. No.: US 2016/0273698 A1
(43) Pub. Date: Sep. 22, 2016

(54) Device and Method for Exhausting Steam in Cured-in-Place Pipelining

(71) Applicant: LMK Technologies, LLC, Ottawa, IL (US)

(72) Inventor: Larry W. Kiest, JR., Ottawa, IL (US)

(73) Assignee: LMK Technologies, LLC, Ottawa, IL (US)

(21) Appl. No.: 15/071,244

(22) Filed: Mar. 16, 2016

Related U.S. Application Data
(60) Provisional application No. 62/133,792, filed on Mar. 16, 2015.

(51) Int. Cl. F16L 55/18; F16L 55/165; B29C 33/10; B29C 43/10; B29C 43/36

(52) U.S. Cl. CPC F16L 55/18; B29C 43/10; B29C 43/3642; B29C 33/10; F16L 55/165; B29K 2105/258

(57) ABSTRACT

A method and apparatus for exhausting steam in steam curing a cured-in-place liner that avoids directing the steam toward a house or building in communication with a pipeline in need of repair. One embodiment includes the use of a liner, a bladder, and an exhaust hose operatively connected to the bladder. A resinous material capable of curing and hardening is applied to the liner. The bladder presses the liner against the pipeline. The end of the steam exhaust hose connected to the bladder is positioned on the interior of the bladder and the opposite end of the steam house is positioned outside the bladder to direct steam away from the house or building as steam is introduced inside the bladder to assist in curing the resinous material.

This application is based upon U.S. Provisional Application Ser. No. 62/133,792 filed Mar. 16, 2015, the complete disclosure of which is hereby expressly incorporated by this reference.

### BACKGROUND

The invention relates generally to a device and method for repairing a pipe or other underground structure, such as an underground sewer pipe in communication with a house or building. More particularly, but not exclusively, the invention relates to a method of exhausting steam in steam curing a cured-in-place liner that avoids venting or directing steam toward the house or building.

As the infrastructure of major cities and towns in the developed world age, the sewer systems weaken. Pipe degradation, system blockage, water infiltration, and sewer leakage are major problems that aging sewer systems experience. As these problems persist, the sewer system may eventually experience total failure and entire sections of the sewer system may collapse. As a result, sinkholes may form and sewers may back up into homes and places of business. One method of addressing this critical infrastructure problem is the use of pipe lining techniques to rehabilitate existing sewer systems.

Cured-in-place pipelining (CIPP) is one such technique that includes rehabilitating an existing sewer system by creating a new pipe within an existing pipe. A liner, impregnated with a resinous material capable of curing and hardening, is inverted or pulled into a damaged pipe. The liner is pressed against the wall of the existing pipe, and the resinous material is allowed to cure and harden. The result is a replacement pipe having the older pipe or “host pipe” on the exterior. The cured-in-place pipe acts to alleviate the problems caused by structural defects and blockages in the existing sewer system.

The use of steam to cure CIPP liners has become commonplace. Steam is used in conjunction with pressurized air in a bladder to keep the liner pressed against the host pipe and distribute the steam from one end of the liner to other. An exhaust port is typically provided at one end of the bladder to allow for continuous flow-through without deflating the bladder prior to completing the curing process. For example, where a lateral liner is inverted from a main pipe into a lateral pipe and steam is used to cure the resin in the liner, the exhaust port will be at the end of the bladder nearest the house or building connected to the lateral pipe. The steam normally has an unpleasant odor. Thus, when the exhausted steam backs up into the house or building, the occupants are subjected to unpleasant odors.

Thus, there is a need in the art for a device and method for exhausting steam away from the house or building in communication with the pipeline.

### SUMMARY

One aspect of the invention includes a method of exhausting steam in steam curing a cured-in-place liner that avoids directing the steam toward a house or building in communication with a pipeline in need of repair. The method generally includes the use of a liner, a bladder, and an exhaust hose operatively connected to the bladder. A resinous material capable of curing and hardening is applied to the liner. The bladder presses the liner against the pipeline. The end of the steam exhaust hose connected to the bladder is positioned on the interior of the bladder and the opposite end of the steam house is positioned outside the bladder to direct steam away from the house or building. Steam is introduced inside the bladder to assist in curing the resinous material, and the exhaust hose exhausts steam outside of the bladder and away from the house or building in communication with the pipeline.

Another aspect of the invention includes an apparatus for repairing a damaged section of a pipeline. The apparatus generally includes a bladder, a liner and an exhaust hose. A closed end of the bladder is operatively connected to one end of the exhaust hose. With inversion of the liner and bladder into the pipeline, the end of the exhaust hose connected to the bladder is disposed within the bladder and extends toward the opposite end of the bladder.

Another aspect of the invention includes a method of exhausting steam in steam curing a cured-in-place liner assembly disposed at the junction between a main and lateral sewer pipe. In steam curing the liner assembly, an exhaust hose directs steam through away from the house or building in communication therewith. In one embodiment the steam is exhausted into the main pipe. In alternate embodiments the steam is exhausted into the lateral pipe or a cleanout pipe.

Yet another aspect of the invention includes an apparatus for repairing the junction between a main sewer pipe and lateral sewer pipe that includes an exhaust hose to effectively exhaust steam in a steam curing process as described above.

These and other aspects of the invention will be illustrated in exemplary embodiments described and shown herein.

### BRIEF DESCRIPTION OF THE DRAWINGS

FIG. 1 is a perspective view of an embodiment of the invention.

FIG. 2 is a section view of an embodiment of the invention positioned in a pipe system before inversion.

FIG. 3 is a section view of an embodiment of the invention positioned in a pipe system after inversion.

FIG. 4 is a perspective view of an embodiment of the invention.

FIG. 5 is a section view of an embodiment of the invention positioned in a pipe system before inversion.

FIG. 6 is a section view of an embodiment of the invention positioned in a pipe system after inversion.

### DETAILED DESCRIPTION OF EXEMPLARY EMBODIMENTS

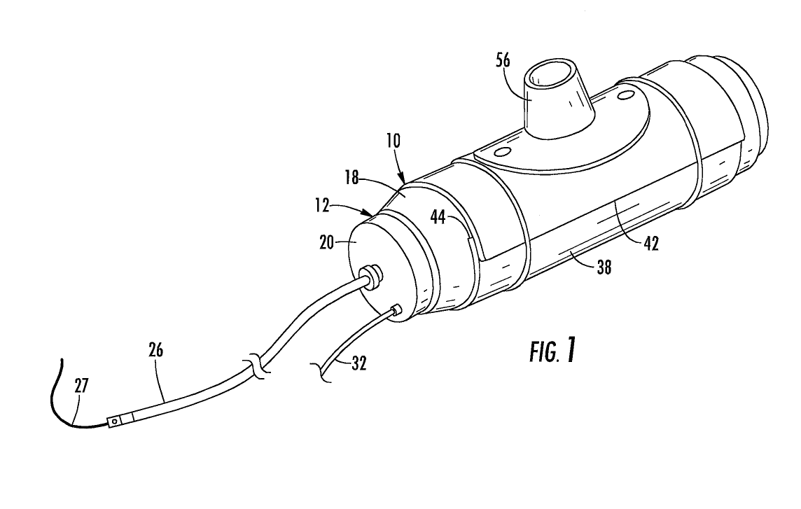

Referring to FIGS. 1-3, a repair assembly is generally designated by the numeral 10. Repair assembly 10 includes a launcher device 12 having mounted thereto a liner assembly 14. In one embodiment the liner assembly 14 is an elongated tube adapted to line the inside of a single length of pipe. In alternate embodiments, a T-shaped or Y-shaped liner assembly 14 may be used to line the intersection of two pipes, such as a main pipe 50 and a lateral pipe 52. Repair assembly 10 also houses a bladder assembly 16, which may be an elongated tube adapted be positioned inside the liner assembly 14 used to line a single length of pipe. Alternatively, the bladder assembly 16 may be a T-shaped or Y-shaped bladder assembly 16. T-shaped or Y-shaped bladder tube assembly 16 includes a main bladder tube 34 and a lateral bladder tube 36. Similarly, the T-shaped or Y-shaped liner assembly 14 includes a main liner tube 38 and a lateral liner tube 40. The bladder assembly 16 is fitted on the interior of the liner assembly 14. In the particular configuration shown in FIGS. 1-3, the liner assembly 14 and bladder assembly 16 are T-shaped, but they can also be single tubes to line a single pipe or a Y-shaped to accommodate a lateral pipe that intersects with a main pipe at an oblique angle.

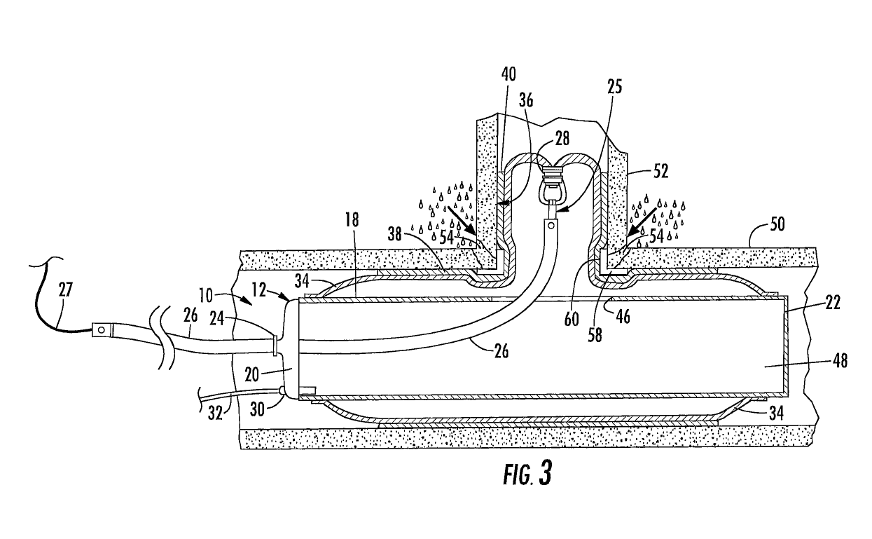

Launcher device 12 includes side walls 18, a first end 20 and an opposite end wall 22. The first end 20 includes an aperture 24 through which an exhaust hose 26 extends. A first end of the exhaust hose 26 is connected to an inversion rope 27 and a second end of the exhaust hose 26 is connected to a closed bladder tube end 28 or operatively connected to the bladder tube end 28 through a second inversion rope 25, B-ring, or other connecting means (FIG. 3). In one embodiment the exhaust hose 26 is inserted through the aperture 24 before being connected to the closed bladder tube end 28. Also extending through first end 20 of the launcher device 12 is an air inlet port 30 and a back pressure port. The air inlet port 30 is connected to a source of pressurized air (not shown) via an air hose 32. The back pressure port and associated back pressure hose and pressure gauge can be used to monitor the static pressure when pressurized air is provided to the launcher cavity 48.

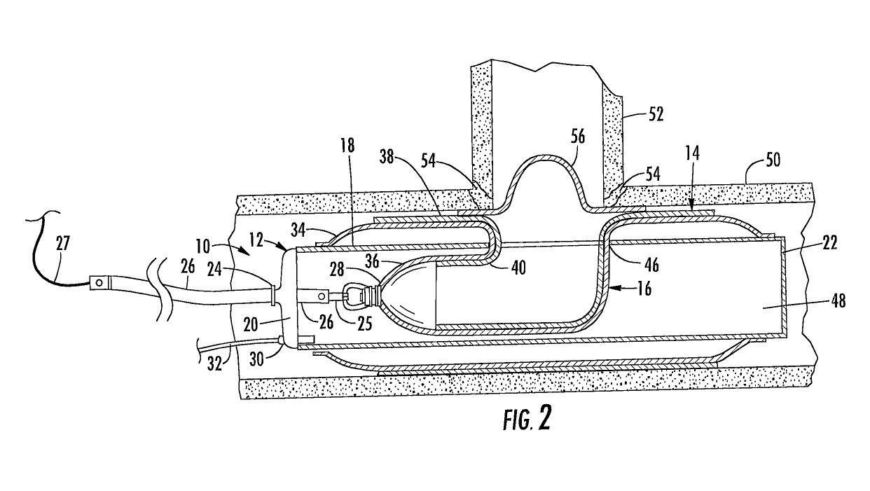

As can be seen in FIG. 1, the main liner tube 38 is comprised of what is initially a flat sheet of material which is wrapped around the outside of the main bladder tube 34 and the launcher device 12. The main liner tube 38 includes overlapping edges 42, 44. The launcher device 12 includes a launcher device opening 46, and the lateral liner tube 40 is contained within the launcher device cavity 48 as shown in FIG. 2. Similarly, the lateral bladder tube 36 is contained within the launcher cavity 48 and surrounds the lateral liner tube 40. Both the main liner tube 38 and the lateral liner tube 40 are comprised of a felt layer, which is the lining surface that contacts the interior surface of the host pipe, and a polymer coating is on the opposite surface. A resinous material capable of curing and hardening is applied to the felt layer of the main liner tube 38 and the lateral liner tube 40 using a vacuum impregnation process, as is known in the art, preferably prior to loading the liner assembly 14 on the launcher device 12.

As described above, the main portion of the liner assembly 14 is preferably formed as a tube. However the main liner member can be sized so that it only engages a portion of the cylindrical main pipe 50.

FIGS. 2 and 3 show the repair assembly 10 within a main pipe 50 which is connected to a lateral pipe 52. The damaged portion 54 is shown needing repair. Ground water from outside the lateral pipe 52 and the main pipe 50 will seep through the damaged portion 54 and enter the interior of the main pipe 50 and the lateral pipe 52.

To help prevent this seepage of ground water, some embodiments include a gasket 56 which can be positioned about a portion of the liner assembly 14. The gasket 56 includes a tubular portion 60 and a flange portion 58 that extends outwardly about the periphery of one end of the tubular portion 60. The flange portion 58 of the gasket 56 is preferably attached to the main liner tube 38 around the juncture between the main liner tube 38 and the lateral liner tube 40 so as to maintain the gasket 56 in proper position as the repair assembly 10 is positioned for operation. The gasket 56 is preferably made of a hydrophilic material capable of swelling in response to being exposed to water or other liquid. However, other materials for the gasket 56 found suitable include neoprene rubber, other similar gasket materials such as urethane or silicone rubber, and like impermeable compressible materials, as disclosed in U.S. Pat. No. 7,975,726, which is incorporated by reference.

FIG. 2 shows the repair assembly 10 moved within the main pipe 50 adjacent the lateral pipe 52. The launcher device opening 46 is positioned so that it faces the junction between a lateral pipe 52 and the main pipe 50. This alignment may be done with a camera (not shown). The lateral bladder tube 36 and the lateral liner tube 40 are contained within the launcher cavity 48.

Pressurized air is introduced in the cavity 48 through air hose 32, urging the liner tube assembly 14 into contact with the interior walls of the main pipe 50 and the lateral pipe 52. Continued air pressure causes the lateral bladder tube 36 and the lateral liner tube 40 to invert outwardly through the launcher device opening 46 into the lateral pipe 52 from the position shown in FIG. 2 to the position shown in FIG. 3. It should be noted that this inversion process causes the lateral liner tube 40 to be placed on the outside of the bladder tube 36 once the inversion is complete, as shown in FIG. 3. In this position, the gasket 56 is positioned between the main liner tube assembly 14 and the interior walls of the main pipe 50 and between the lateral liner tube assembly 16 and the interior walls of the lateral line 52.

Pressure within the cavity 48 is maintained until the resinous material cures and hardens. This results in the liner assembly 14 assuming a rigid configuration, forming a lining to the lateral pipe 52 and the main pipe 50. To activate and accelerate the curing process, steam combined with pressurized air is introduced into the system through the air inlet port 30. The pressurized steam passes through the launcher device 22 and into the inflated bladder assembly 16. The resinous material is exposed to heat from the steam. The steam is made from a boiler positioned above ground, as is known in the art.

To provide a sufficient amount of steam and maintain the appropriate temperature for curing, the pressurized steam displaces air in the system by exhausting the air through the exhaust hose 26. Eventually steam will reach the end of the first end of the exhaust hose near the closed end of the lateral bladder tube 36. As pressurized steam continues to be supplied to the system, a portion of the steam will pass through the exhaust hose 26 which has an opening near each end. In the embodiment shown, the second end of the exhaust hose 26 is positioned outside the bladder tube 36 in the main pipe 50. The exhausted steam condenses and flows downstream in the main pipe 50. In another embodiment the liner and bladder are inverted from a cleanout pipe into the lateral pipe 52 toward the main pipe 50. In this alternate embodiment the second end of the exhaust hose 26 extends into a cleanout pipe.

The exhaust hose 26 is preferably made from a high-pressure/high-temperature hose, such as commonly found on the air brake system of a semi-tractor trailer. Such a hose can withstand the temperatures and pressures of the application with a minimal wall thickness. In one embodiment, at each end of the exhaust hose 26, a ring is welded onto a hollow hose barb that is clamped onto the hose. An inversion rope 25 secures one end of the exhaust hose 26 to the closed end of the bladder. Alternatively, the exhaust hose 26 can be directly connected the closed end of the lateral bladder 36. A separate inversion rope 27 connects the opposite end of the exhaust hose 26 with a hose reel above ground (not shown).

In one embodiment, one end of the exhaust hose 26 is positioned near the closed end of the lateral bladder tube 36. In this configuration, the steam must travel to the far end of the inverted bladder assembly 14 before it can enter the exhaust hose 26 and be exhausted out the opposite end of exhaust hose 26 disposed outside the bladder assembly 14, such as in the main pipe 50. This helps ensure that heat from the steam is supplied to the resinous material in both the main liner member 38 and the length of the lateral liner tube 36.

The exhaust hose 26, in its preferred form, provides several functions. First, the exhausts hose 26 effectively exhausts steam into the main pipe 50. As such, the exhausted steam may be directed away from the house or building in communication with the lateral pipe 52 and thus not subjecting the occupants to unpleasant odors from the steam. Further, the exhaust hose 26 is substituted for a portion of the inversion rope 27. An inversion rope 27, as is known in the art, is used to help control the rate at which the liner tube 36 inverts into the host pipe. Additionally, the same inversion rope 27 can be used to remove the bladder 36 from the pipe. An operator or hose reel pulls on the inversion rope 27 to peal the lateral bladder tube 36 away from the lateral liner tube 40 and reinvert it back into the launcher device 12 and/or lay flat hose 21 (as described below). As shown above, the exhaust hose 26 in combination with the inversion ropes 25 and 27 provide the same function. This is one embodiment, and it can be appreciated that a separate inversion rope 27 could also be used that does not rely on the exhaust hose 26.

Use of the exhaust hose 26 is not limited to CIPP applications where the juncture between two pipes is being repaired. For example, those skilled in the art having the benefit of this disclosure will appreciate that the exhaust hose 26 could be used in lining just a portion of a lateral pipe 52.

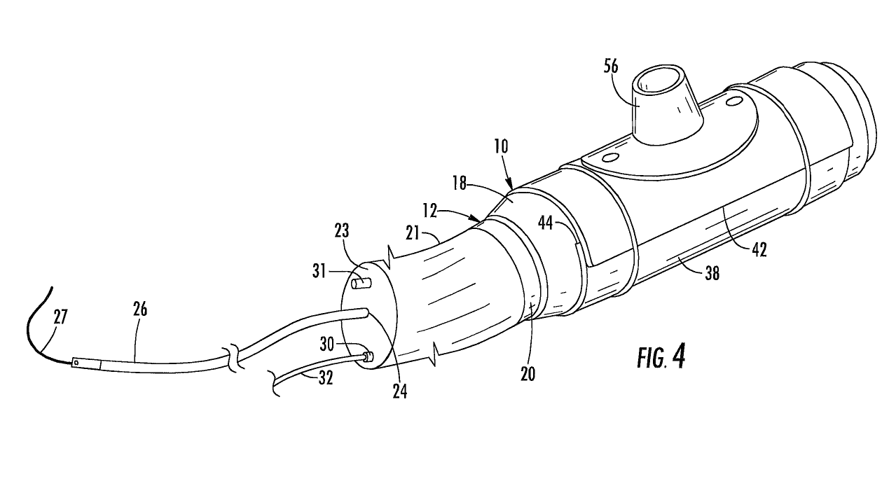

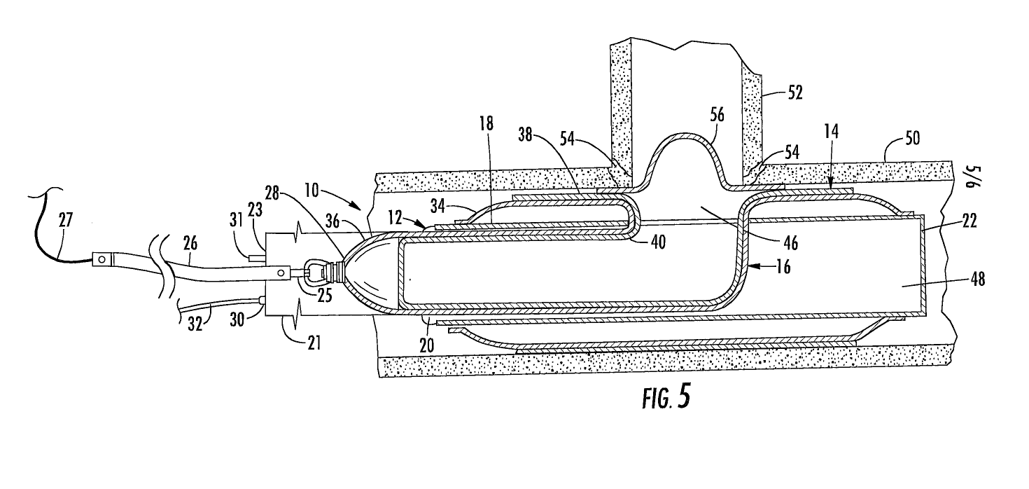

FIGS. 4, 5, and 6 illustrate a version of the present invention wherein a lateral liner tube 40 and lateral bladder tube 36 are loaded in a launcher device 12 with a lay flat hose 21 extension. The lay flat hose 21 is fluidly connected to the first end 20 of the launcher device 12. The opposite end of the lay flat hose 21 is connected to an end cap 23. The lay flat hose 21 provides for the storage, positioning, and application of pressurized fluid to an extended portion of the liner assembly 14. The lay flat hose 21, end cap 23, and launcher device 12 form a launcher cavity 48. The end cap 23 includes an aperture 24 through which an exhaust hose 26 extends. A first end of the exhaust hose 26 is connected to an inversion rope 27. A second end of the exhaust hose 26 is directly connected to a closed bladder tube end 28 or operatively connected through a second inversion rope 25, d-ring, or other connecting means (FIG. 5). Also extending through end cap 23 is an air inlet port 30 and a back pressure port 31. The air inlet port 30 is connected to a source of pressurized air (not shown) via an air hose 32. The back pressure port 31 and associated back pressure hose 33 and pressure gauge (not shown) can be used to monitor the static pressure between the lay flat hose 21 and the bladder assembly 16 when pressurized air is provided to the launcher cavity 48.

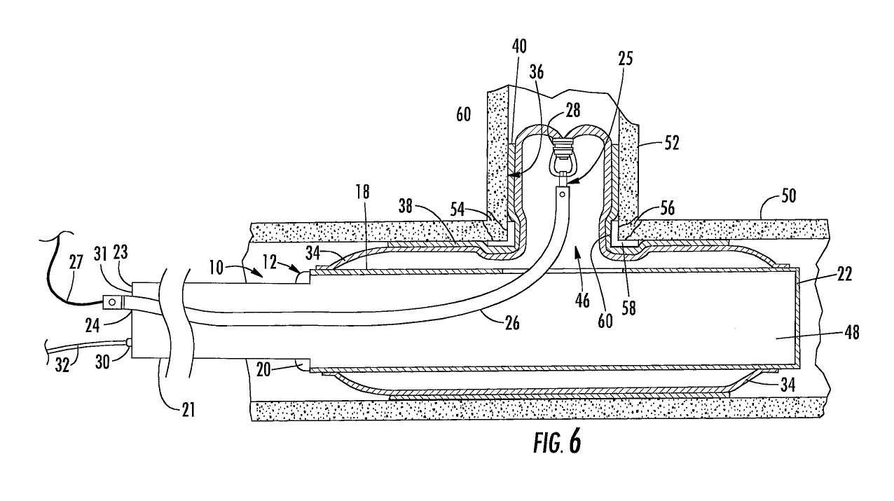

Similar to the description of the embodiment shown in FIGS. 1-3, one end of the exhaust hose 26 is secured near the closed end of the bladder tube 36 with an inversion rope 27. Once the lateral liner tube 36 and lateral bladder tube 40 are inverted into the lateral pipe 52 (see FIG. 6), the steam curing process begins as previously described. Steam in the internal cavity of the lay flat hose 21 and/or launcher device 12 eventually reaches and enters a first opening in the first end of exhaust hose 26 near the closed end of the bladder tube 36 and passes through the exhaust hose 26 and out a second opening in the exhaust hose 26 near the second (opposite) end. This second end of the exhaust hose 26 may extend in a direction away from the house or building in communication with the lateral pipe 52 and may be positioned outside the launcher device 12 and/or lay flat hose 21. In the embodiment shown, the second end of the exhaust hose 26 is positioned outside the bladder tube 36 in the main pipe 50. The exhausted steam condenses and flows downstream in the main pipe 50. In another embodiment the liner and bladder are inverted from a cleanout pipe into the lateral pipe 52 toward the main pipe 50. In this alternate embodiment the second end of the exhaust hose 26 extends into a cleanout pipe.

The exhaust hose 26 could also be used in inversion-type applications without a bladder. Here the impermeable coating on the liner assembly 14 would allow the liner to invert with air pressure. In this embodiment, the first end of the exhaust hose 26 is attached to a portion of the liner assembly 14. The exhaust hose 26 extends through the aperture 24 in the launcher device 12 and/or aperture 24 in the lay flat hose 21 so the second end of the exhaust hose 26 is outside of the liner assembly 14 and preferably outside of the launcher device 12 and/or lay flat hose 21. U.S. Pat. No. 7,845,372 filed Mar. 30, 2007 describes such a bladderless application and is incorporated herein by reference.

While the preferred apparatus and methods for exhausting steam described are intended for use with an inversion-type application, those skilled in the art will appreciate that the exhaust hose 26 can also be used in pull-in-place applications. The exhaust hose 26 would preferably be positioned near one end of the bladder and exhaust the steam out through the other end of the bladder.

The invention has been shown and described above with reference to the preferred embodiments, and it is understood that many modifications, substitutions, and additional may be made which are within the intended spirit and scope of the invention.

1. A method of exhausting steam in steam curing a cured-in-place liner in a pipeline in need of repair, the method comprising:
taking a liner having a closed end;
taking an exhaust hose having first and second opposite ends;
operatively connecting the first end of the exhaust hose to the closed end of the liner;
applying a resinous material to the liner capable of curing and hardening;
positioning the liner against the pipeline with the first end of exhaust hose being on the inside of the liner;
introducing steam inside the liner to assist in curing the resinous material; and
exhausting at least a portion of the steam through the exhaust hose and outside the liner.

2. The method of claim 1 wherein the first end of the exhaust hose is connected to the liner through an intermediate member.

3. The method of claim 2 wherein the intermediate member is a rope.

4. The method of claim 1 wherein the liner is inverted to position the liner against the pipeline.

5. The method of claim 1 wherein the liner is pulled into the pipeline to position the liner against the pipeline.

6. A method of exhausting steam in steam curing a cured-in-place liner in a pipeline in need of repair, the method comprising:
taking a liner;
taking a bladder having first and second opposite ends, the first end being closed;
taking an exhaust hose having first and second opposite ends;
operatively connecting the first end of the exhaust hose to the bladder;
applying a resinous material to the liner capable of curing and hardening;
positioning the liner against the pipeline with the bladder being on the inside of the liner and the first end of exhaust hose being on the inside of the bladder;
introducing steam inside the bladder to assist in curing the resinous material; and
exhausting at least a portion of the steam through the exhaust hose and outside the bladder.

7. The method of claim 6 wherein the first end of the exhaust hose is connected to the bladder through an intermediate member.

8. The method of claim 7 wherein the intermediate member is a rope.

9. The method of claim 6 wherein the liner and bladder are inverted to position the liner against the pipeline.

10. The method of claim 6 wherein the liner and bladder are pulled into the pipeline to position the liner against the pipeline.

11. The method of claim 6 wherein the first end of the exhaust hose is operatively connected to the first end of the bladder.

12. The method of claim 11 further comprising deflating the bladder and removing the bladder from the pipeline after the resinous material has cured and hardened by pulling on the exhaust hose.

13. The method of claim 6 wherein the resinous material is applied to the liner after the exhaust hose is operatively connected to the bladder.

14. The method of claim 6 further comprising taking a launcher device having an aperture in one end and securing at least a portion of the liner to the launcher device.

15. The method of claim 14 further comprising inserting one end of the exhaust hose through the aperture in the launcher device before connecting the first end of the exhaust hose to the bladder.

16. The method of claim 6 further comprising positioning a gasket about a portion of the liner assembly.

17. The method of claim 6 wherein the pipeline includes a main pipe and a lateral pipe and the liner assembly includes a main liner tube positioned against the main pipe and a lateral liner tube positioned against the lateral pipe.

18. The method of claim 6 wherein the liner is disposed at the junction between a main and lateral sewer pipe.

19. An apparatus for repairing a damaged section of a pipeline, comprising:
a bladder having first and second opposite ends;
a liner positioned at least partially within the bladder;
an exhaust hose having first and second opposite ends;
wherein the first end of the bladder being closed and operatively connected to the first end of the exhaust hose with the exhaust hose extending away from the second end of the bladder on the outside of the bladder;
whereby with inversion of the liner and bladder into the pipeline the first end of the exhaust hose is disposed within the bladder and extends toward the second end of the bladder.

20. The apparatus of claim 19 wherein the exhaust hose is positioned proximate the first end of the bladder.

22. The apparatus of claim 19 further comprising a launcher device having an aperture in one end.

23. The apparatus of claim 22 wherein the exhaust hose extends through the aperture.

24. The apparatus of claim 22 further comprising a lay flat hose fluidly connected to the aperture, said lay flat hose having an end cap with an aperture therein, wherein the exhaust hose extends through the aperture in the lay flat hose.

25. The method of claim 19 further comprising positioning a gasket about a portion of the liner assembly.

26. The method of claim 19 wherein the pipeline includes a main pipe and a lateral pipe and the liner assembly includes a main liner tube positioned against the main pipe and a lateral liner tube positioned against the lateral pipe.

27. The method of claim 19 wherein the liner is disposed at the junction between a main and lateral sewer pipe.

28. A method of exhausting steam in steam curing a cured-in-place liner that avoids directing the steam toward a house or building in communication with a lateral sewer pipe joined to a main sewer pipe, the method comprising:
taking a liner assembly including a lateral portion and a main portion;
taking a lateral bladder having first and second opposite ends, the first end being closed;
taking a main bladder;
taking an exhaust hose having first and second opposite ends;
operatively connecting the first end of the exhaust hose to the first end of the lateral bladder;
applying a resinous material to the liner assembly capable of curing and hardening;
taking a launcher device having opposite ends and a launcher device opening between the ends;
positioning the lateral portion of the liner assembly at least partially on the inside of the lateral bladder;
securing the main bladder to the launcher device;
positioning the main portion of the liner assembly on the outside of the main bladder with the lateral portion of the liner assembly and the lateral bladder extending through the launcher device opening at least partially into the launcher device;
moving the launcher device through the main sewer pipe to a position where the launcher device opening is aligned with the lateral sewer pipe;
inflating the main bladder to press the main portion of the liner assembly against the main sewer pipe;
inflating the lateral bladder to invert the lateral bladder and the lateral portion of the liner assembly within the lateral sewer pipe with the lateral portion being on the outside of the lateral bladder and pressed against the lateral sewer pipe;
introducing steam within the lateral bladder to assist in curing the resinous material; and
exhausting at least a portion of the steam from the inside of the bladder to the outside of the bladder through the exhaust hose and away from the house or building.

29. The method of claim 28 wherein the first end of the exhaust hose is connected to the first end of the bladder through an intermediate member.

30. The method of claim 28 wherein the intermediate member is a rope.

31. The method of claim 28 further comprising deflating the lateral bladder and removing the lateral bladder from the pipeline after the resinous material has cured and hardened.

32. The method of claim 28 wherein the lateral bladder is removed from the pipeline by pulling on the exhaust hose.

33. The method of claim 28 wherein the main bladder and the lateral bladder are fluidly connected.

34. The method of claim 28 wherein the exhaust hose extends within the lateral bladder and through the launcher device to exhaust the steam.
